(19) United States
(12) Patent Application Publication
(10) Pub. No.: US 2013/0314554 A1
(43) Pub. Date: Nov. 28, 2013

(54) ELECTRONIC DECORATION SYSTEM, METHOD, AND SERVER

(71) Applicants: YI-WEN CAI, Tu-Cheng (TW); SHIH-CHENG WANG, Tu-Cheng (TW)

(72) Inventors: YI-WEN CAI, Tu-Cheng (TW); SHIH-CHENG WANG, Tu-Cheng (TW)

(73) Assignee: HON HAI PRECISION INDUSTRY CO., LTD., Tu-Cheng (TW)

(21) Appl. No.: 13/477,104

(22) Filed: May 22, 2012

(51) Int. Cl. H04N 5/225

(52) U.S. Cl. 348/207.1; 348/E05.024

(57) ABSTRACT

An electronic decoration system is provided, including a third-party server cloud and display devices with a display disposed in a structure. The third-party server cloud includes an input unit, a conversion unit, a subscription unit, and an output unit. The conversion unit produces theme data according to input data received by the input unit. The subscription unit stores subscription information including a theme category name and subscriber identifications. When a category of the theme data corresponds to the theme category name and an identification of the display device corresponds to one of the subscriber identifications, the subscription unit enables the output unit to transmit the theme data to the display device, thereby enabling the display to display scenes according to the theme data. The disclosure further provides a server for the electronic decoration system and an electronic decoration method.

### CROSS-REFERENCE OF RELATED APPLICATIONS

Relevant subject matters are disclosed in a co-pending U.S. patent application (application Ser. No. 13/437996), which is assigned to the same assignee as this patent application.

### BACKGROUND

1. Technical Field

The present disclosure relates to an electronic decoration system, and particularly to an electronic decoration system using third-party servers to provide theme data for display of scenes to display devices with a display disposed in a structure.

2. Description of Related Art

Most conventional electronic wallpaper displays scenes of images according to multimedia data received from a device coupled to the electronic wallpaper, for example, a computer. However, the multimedia data is usually provided according to a pre-stored multimedia file in the device which is manually chosen by a user. Hence, the scenes displayed by the electronic wallpaper depend on multimedia files stored in the device, and cannot be changed until the user chooses another multimedia file in the device.

What is needed, therefore, is a system capable of overcoming the limitations described.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an electronic decoration system of the present disclosure.

FIG. 2 is a schematic diagram of an embodiment of the display device shown in FIG. 1.

FIG. 3 is a schematic diagram of another embodiment of a display device of an electronic decoration system of the present disclosure.

FIG. 4 is a flowchart of an embodiment of an electronic decoration method implemented through the electronic decoration system shown in FIG. 1.

### DETAILED DESCRIPTION

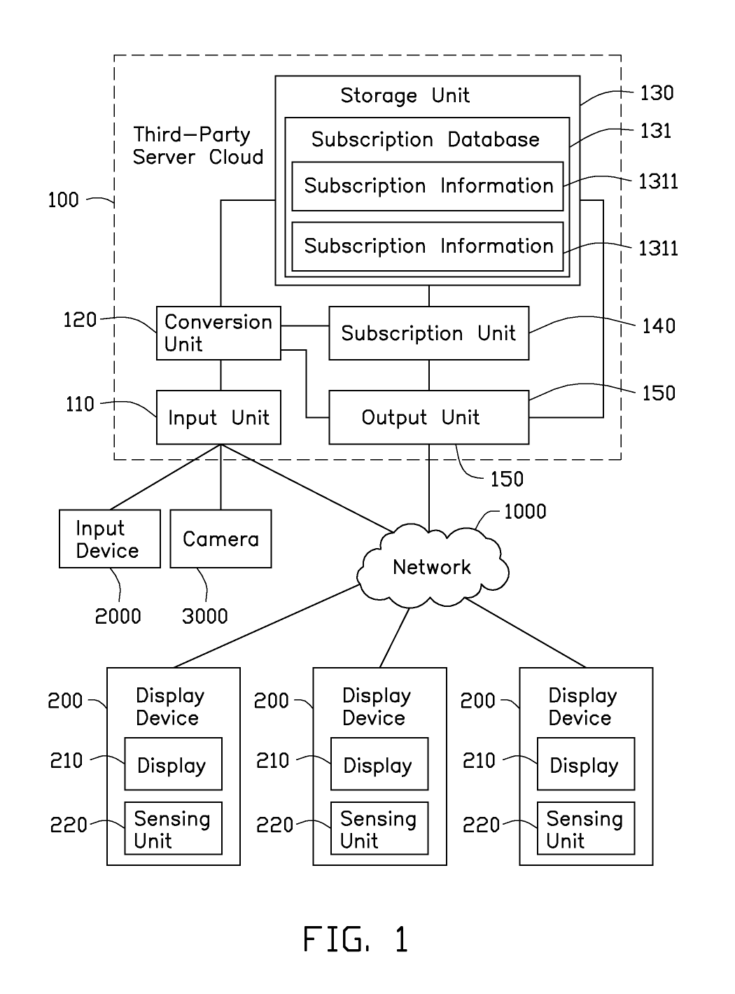

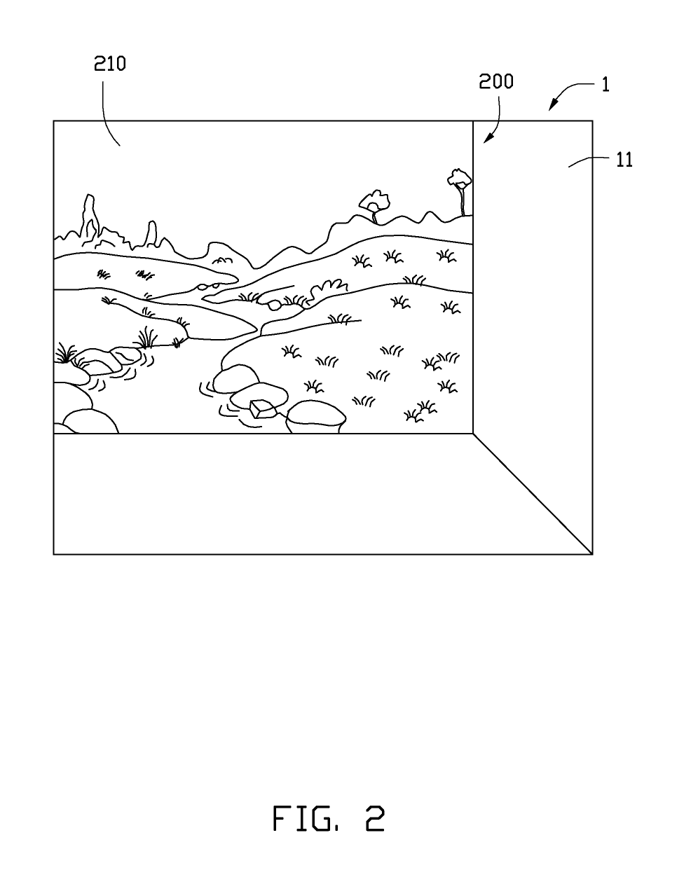

FIG. 1 is a block diagram of an embodiment of an electronic decoration system of the present disclosure. The electronic decoration system includes a third-party server cloud 100 and display devices 200. The third-party server cloud 100 communicates with the display devices 200 through a network 1000, which may include one or more servers. In the illustrated embodiment, the network 1000 is a wired network such as an Ethernet network. In other embodiments, the network 1000 can be another type of wired network or a wireless network such as Wi-Fi network or BLUETOOTH network. Each of the display devices 200 includes a display 210 and a sensing unit 220. The display 210 is disposed in a structure 1 (see FIG. 2) such as a building or a vehicle, which displays scene(s) containing image(s) and/or video(s) such as patterns, paintings, still photographs, or animations according to theme data Dt (not shown) received from the third-party server cloud 100. The sensing unit 220 may include sensor(s) disposed in or outside of the structure 1, which may detect local environmental parameters P1 (not shown) of the environment such as air temperature, humidity, luminosity, visibility, atmospheric pressure, cloudiness, evaporation, wind velocity, flow velocity, and/or shaking intensity, for example.

The third-party server cloud 100 includes an input unit 110, a conversion unit 120, a storage unit 130, a subscription unit 140, and an output unit 150. In the illustrated embodiment, the input unit 110 receives input data Di (not shown) from an input device 2000 or a camera 3000 through, for example, a computer input output interface, a wired/wireless network, or another type of digital/analog signal interface such as coaxial cable. The input unit 110 can also receive display device configuration parameters Pd (not shown) of the display device 200 from the display device 200 through the network 1000, and the local environmental parameters P1 from the sensing unit 220 of the display device 200 through the network 1000. The input data Di is composed of data packets such as USB (universal serial bus) packets, Ethernet frames, or Wi-Fi packets. The input data Di may include multimedia file(s) including, for example, a pattern, a painting, a still photograph, or an animation. The input device 2000 is an individual device, for example, a computer, a multimedia player, or a portable device, which is coupled to the third-party server cloud 100. The camera 3000 produces the input data Di including image(s) such as still photograph(s) or video(s) of, for example, a scenic spot or a particular scene. In other embodiments, the input unit 110 can receive the input data Di from other types of devices such as sensors for detecting environmental parameters. The input data Di can be composed of other types of data with a particular format. In addition, the input device 2000 can be a component of the third-party server cloud 100, for example, a storage device such as a high speed random access memory, a non-volatile memory, or a hard disk drive.

The conversion unit 120 produces the theme data Dt according to the input data Di. The theme data Dt is then stored in the storage unit 130. In the illustrated embodiment, the conversion unit 120 produces the theme data Dt by deriving the contents in the data packets of the input data Di which corresponds to the scene(s) to be displayed by the display 210 of the display devices 200 from the input data Di, and integrating the contents with a category name C, wherein the contents can be, for example, a pattern, a painting, a still photograph, or an animation, and the category name C can be the name of the source, the author, the classification, or the type of the theme data Dt. In other embodiments, the conversion unit 120 can produce the theme data Dt by integrating the contents with other related information of the contents, or by merely deriving the contents from the input data Di.

When the input unit 110 receives the display device configuration parameters Pd, the conversion unit 120 produces the theme data Dt further according to the display device configuration parameters Pd in addition to the input data Di, while the display device configuration parameters Pd of the display devices 200 can be individually stored in the storage unit 130 for next uses. The display device configuration parameters Pd can be manually inputted by a user, or be automatically provided by the display devices 200. The display device configuration parameters Pd may include specification information of the display 210 such as the display DPI (dots per inch) or the display size of the display 210, and may include disposition information of the display 210 such as the location of the display 210 on the wall 11 of the structure 1. For instance, the conversion unit 120 can determine the characteristics of the scene(s) displayed by the display 210, for example, the size of the scene(s), according to the display size of the display 210 when producing the theme data Dt. In addition, the conversion unit 120 can modify the theme data Dt stored in the storage unit 130 according to the display device configuration parameters Pd.

When the input unit 110 receives the local environmental parameters P1, the conversion unit 120 produces the theme data Dt further according to the local environmental parameters P1 in addition to the input data Di. For instance, the conversion unit 120 can adjust the characteristics of the scene(s) displayed by the display 210 such as the color tone of the scene(s), according to the air temperature of the environment where the display device 200 is located when producing the theme data Dt. In addition, the conversion unit 120 can modify the theme data Dt stored in the storage unit 130 according to the local environmental parameters P1.

The storage unit 130 includes a subscription database 131 storing subscription information 1311. The storage unit 130 is a device such as a high speed random access memory, a non-volatile memory or a hard disk drive for storing and retrieving digital information. The subscription information 1311 is created by, for example, online shopping processes. Each of the subscription information 1311 includes a theme category name N (not shown) and a subscriber list, which records the display devices 200 to receive a category of the theme data Dt corresponding to a theme category. The theme category name N includes the name of the theme category. Themes corresponding to the theme data Dt produced by the conversion unit 120 can be categorized according to, for example, the title (for example, the name of a design), the source (for example, the provider or the retailer), the creator (for example, the designer), the classification (for example, a pattern, a painting, or a photograph), or the type (for example, the style) of the themes. The subscriber list includes subscriber identification corresponding to identification of the display devices 200 receiving the theme data Dt corresponding to the theme category. Table 1, below, shows one of the subscription information 1311 shown in FIG. 1. In the illustrated embodiment, the theme category name N includes the name of a designer, and the subscriber list includes the subscriber identification corresponding to the identification of the display devices 200 receiving the themes designed by the designer. Hence, the design of the designer will be transmitted to the display device 200, which has the identification corresponding to one of the subscriber identification in the subscriber list.

TABLE 1

| Theme category | Sting Cai's series | | | |
|---|---|---|---|---|
| name | | | | |
| Subscriber list | Subscriber | Subscriber | Subscriber | . . . |
| | Identification 1 | Identification 2 | Identification 3 | |
| | DD001 | DD002 | N/A | . . . |

The subscription unit 140 includes an online shopping unit. The online shopping unit can be a website, which includes an online shopping process capable of creating/modifying the subscription information 1311 in the subscription database 131 of the storage unit 130 when a payment corresponding to the online shopping process is accepted. In the online shopping process, the theme category name N and an identification of the corresponding display device(s) 200 are indicated, hence the display device(s) 200 with the identification(s) will receive the theme(s) corresponding to the theme category name N which correspond to, for example, a certain title, source, creator, classification, or type. In response to the conversion unit 120 producing the theme data Dt, the subscription unit 140 determines if the category name C of the theme data Dt produced by the conversion unit 120 corresponds to the theme category name N of one of the subscription information 1311 and the identification of the display device(s) 200 corresponds to one of the subscriber identification in the subscriber list of the subscription information 1311. If so, the subscription unit 140 enables the output unit 150 communicating with the display device(s) 200 through the network 1000 to transmit the theme data Dt to the display device(s) 200. In the illustrated embodiment, the display devices 200 with the identifications of “DD001” and “DD002” will receive the themes designed by “Sting Cai”. The display 210 of the display devices 200 automatically displays the scene(s) according to the theme data Dt when receiving the theme data Dt. In other embodiments, the display 210 can display the scene(s) according to the theme data Dt in response to a manual configuration, for example, a confirmation or a selection.

In addition, if a new subscription information 1311 is created, the subscription unit 140 enables the output unit 150 to transmit the theme data Dt to the corresponding display device(s) 200 when the category name C of the theme data Dt stored in the storage unit 130 corresponds to the theme category name N of the new subscription information 1311 and the identification of the display device(s) 200 corresponds to one of the subscriber identifications in the subscriber list of the new subscription information 1311. If a new subscriber identification is added to the subscriber list of one of the subscription information 1311, the subscription unit 140 enables the output unit 150 to transmit the theme data Dt to the corresponding display device(s) 200 when the category name C of the theme data Dt stored in the storage unit 130 corresponds to the theme category name N of the modified subscription information 1311 and the identification of the display device(s) 200 corresponds to one of the subscriber identifications in the subscriber list of the modified subscription information 1311. Furthermore, when the input unit 110 receives the local environmental parameters P1, the subscription unit 140 can enable the output unit 150 to transmit the theme data Dt according to the local environmental parameters P1. In the illustrated embodiment, the subscription unit 140 can enable the output unit 150 to transmit the theme data Dt complementary to or corresponding to the local environmental parameters P1. For instance, when the subscription unit 140 determines it is cold in the environment where the display device 200 is located according to local environmental parameters P1, the subscription unit 140 enables the output unit 150 to transmit the theme data Dt corresponding to a theme with a warm color to the display device 200.

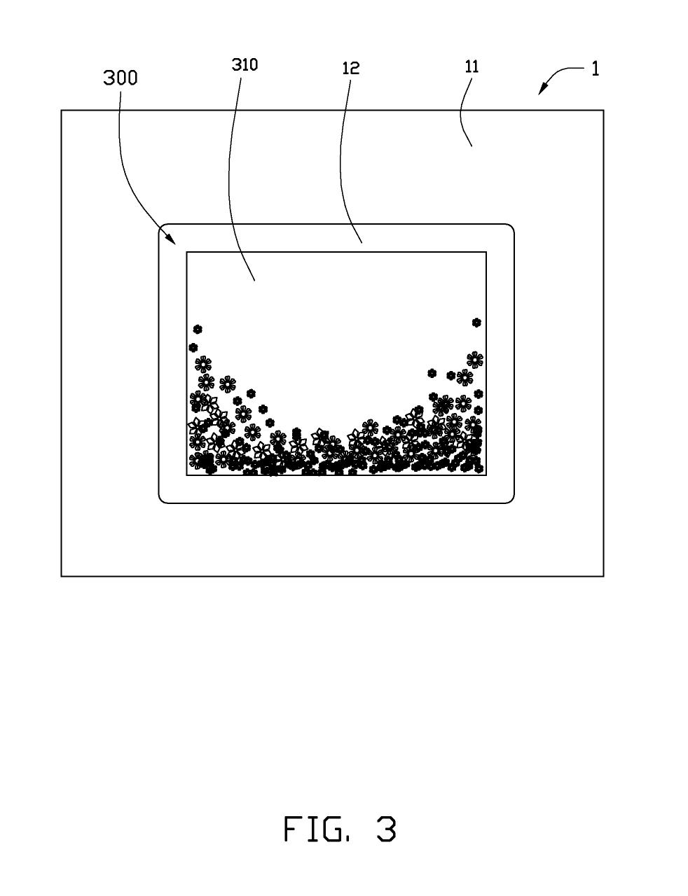

FIG. 2 is a schematic diagram of an embodiment of the display device 200 shown in FIG. 1. In the illustrated embodiment, the display 210 of the display device 200 is an electronic paper fixed on a wall 11 of the structure 1. In other embodiments, the display 210 can be another type of electronic display such as an organic light-emitting diode (OLED) display, and can be fixed on other portions of the structure 1, for example, an opening of the structure 1 such as a window. FIG. 3 is a schematic diagram of another embodiment of a display device 300 of an electronic decoration system of the present disclosure. A display 310 of the display device 300 is an active-matrix organic light-emitting diode (AMOLED) display disposed on a window 12 of the structure 1, wherein the display 310 is substituted for a glass portion of a conventional window. The display 310 can be a transparent AMOLED display which can adjust the transparency by changing, for example, the color or the pattern of a scene displayed by the display 310.

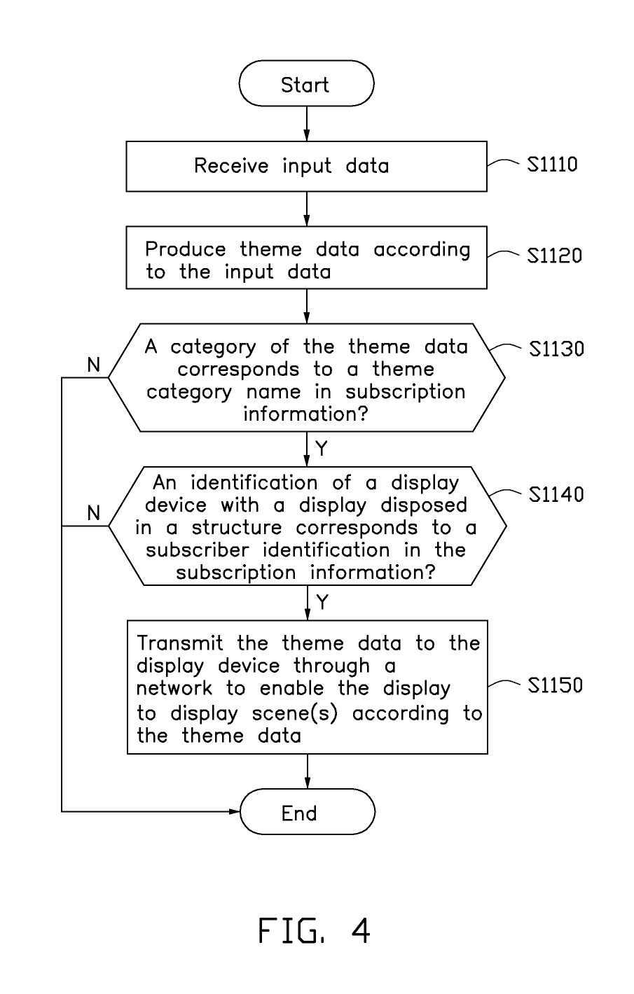

FIG. 4 is a flowchart of an embodiment of an electronic decoration method implemented through the electronic decoration system shown in FIG. 1. The electronic decoration method of the present disclosure follows. Depending on the embodiment, additional steps may be added, others removed, and the ordering of the steps may be changed.

In step S1110, the input data Di is received. In the illustrated embodiment, the input unit 110 receives the input data Di from the input device 2000 or the camera 3000. The input data Di may include multimedia file(s) or image(s). The input unit 110 can also receive the display device configuration parameters Pd of the display device 200 from the display device 200 through the network 1000, and the local environmental parameters P1 from the sensing unit 220 of the display device 200 through the network 1000.

In step S1120, the theme data Dt is produced according to the input data Di. The theme data Dt is then stored. In the illustrated embodiment, the theme data Dt can be produced further according to the display device configuration parameters Pd in addition to the input data Di. In addition, the theme data Dt can be produced further according to the local environmental parameters P1 in addition to the input data Di.

In step S1130, a determination is made as to whether the category of the theme data Dt corresponds to the theme category name N in the subscription information 1311. If yes, step S1140 is implemented; otherwise, the method is terminated.

In step S1140, a determination is made as to whether the identification of the display device 200 with the display 210 disposed in the structure 1 corresponds to the subscriber identification in the subscription information 1311. If yes, step S1150 is implemented; otherwise, the method is terminated.

In step S1150, the theme data Dt is transmitted by the output unit 150 to the display device 200 through the network 1000 to enable the display 210 to display scene(s) according to the theme data Dt. In the illustrated embodiment, if a new subscription information 1311 is created, the theme data Dt is transmitted to the corresponding display device(s) 200 when the category name C of the stored theme data Dt corresponds to the theme category name N of the new subscription information 1311 and the identification of the display device(s) 200 corresponds to one of the subscriber identifications in the subscriber list of the new subscription information 1311. In addition, if a new subscriber identification is added to the subscriber list of one of the subscription information 1311, the theme data Dt is transmitted to the corresponding display device(s) 200 when the category name C of the stored theme data Dt corresponds to the theme category name N of the modified subscription information 1311 and the identification of the display device(s) 200 corresponds to one of the subscriber identifications in the subscriber list of the modified subscription information 1311.

The electronic decoration system and the electronic decoration method utilize third-party servers to provide theme data for displaying scenes to display devices with a display disposed in a structure. Hence, images or videos provided by the third-party service providers can be displayed through the display devices with a display disposed in a structure.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. An electronic decoration system, comprising:
a display device comprising a display disposed in a structure, wherein the display displays one or more scenes according to theme data; and
one or more third-party servers comprising:
an input unit receiving input data;
an output unit communicating with the display device through a network;
a conversion unit producing the theme data according to the input data;
a storage unit storing one or more subscription information comprising a theme category name and one or more subscriber identifications; and
a subscription unit, wherein when a category of the theme data corresponds to the theme category name of the one or more subscription information and an identification of the display device corresponds to one of the one or more subscriber identifications of the subscription information, the subscription unit enables the output unit to transmit the theme data to the display device.

2. The electronic decoration system of claim 1, wherein the display of the display device is fix on at least one of a wall of the structure and an opening of the structure.

3. The electronic decoration system of claim 1, wherein the display of the display device is an electronic paper or an AMOLED (active-matrix organic light-emitting diode) display.

4. The electronic decoration system of claim 1, wherein the input data comprises one or more multimedia files.

5. The electronic decoration system of claim 1, wherein the input unit of the one or more third-party servers receives the input data from one or more cameras.

6. The electronic decoration system of claim 1, wherein the input unit of the one or more third-party servers receives one or more display device configuration parameters of the display device from the display device through the network, the conversion unit produces the theme data further according to the one or more display device configuration parameters.

7. The electronic decoration system of claim 1, wherein the conversion unit stores the theme data in the storage unit, when a new subscriber identification is added to the one or more subscription information, the subscription unit enables the output unit to transmit the theme data stored in the storage unit to the display device while the category name of the theme data corresponds to the theme category name of the modified one or more subscription information and the identification of the display device corresponds to one of the subscriber identifications of the modified one or more subscription information.

8. The electronic decoration system of claim 1, further comprising one or more sensing units connected to the display device, wherein the input unit of one or more third-party servers receives one or more local environmental parameters from the one or more sensing units through the network, the conversion unit of the one or more third-party servers produces the theme data according to the input data and the one or more local environmental parameters.

9. A server for a display device with a display disposed in a structure, comprising:
an input unit receiving input data;
an output unit communicating with the display device with the display disposed in the structure through a network;
a conversion unit producing theme data according to the input data;
a storage unit storing one or more subscription information comprising a theme category name and one or more subscriber identifications; and
a subscription unit, wherein when a category of the theme data corresponds to the theme category name of the one or more subscription information and an identification of the display device corresponds to one of the one or more subscriber identifications of the subscription information, the subscription unit enables the output unit to transmit the theme data to the display device to enable the display of the display device to display one or more scenes according to the theme data.

10. The server of claim 9, wherein the input data comprises one or more multimedia files.

11. The server of claim 9, wherein the input unit receives the input data from one or more cameras.

12. The serve of claim 9, wherein the input unit of the server receives one or more display device configuration parameters of the display device from the display device through the network, the conversion unit produces the theme data further according to the one or more display device configuration parameters.

13. The serve of claim 9, wherein the conversion unit stores the theme data in the storage unit, when a new subscriber identification is added to the one or more subscription information, the subscription unit enables the output unit to transmit the theme data stored in the storage unit to the display device while the category name of the theme data corresponds to the theme category name of the modified one or more subscription information and the identification of the display device corresponds to one of the subscriber identifications of the modified one or more subscription information.

14. The server of claim 9, wherein the input unit receives one or more local environmental parameters from one or more sensing units connected to the display device through the network, the conversion unit produces the theme data according to the input data and the one or more local environmental parameters.

15. An electronic decoration method for a display device with a display disposed in a structure, the electronic decoration method comprising:
receiving input data;
producing theme data according to the input data;
determining whether a category of the theme data corresponds to a theme category name in subscription information and an identification of the display device with the display disposed in the structure corresponds to a subscriber identification in the subscription information; and
transmitting the theme data to the display device through a network to enable the display to display one or more scenes according to the theme data when the category of the theme data corresponds to the theme category name in the subscription information and the identification of the display device corresponds to the subscriber identification in the subscription information.

16. The electronic decoration method of claim 15, wherein the step of receiving the input data comprises:
receiving the input data comprising one or more multimedia files.

17. The electronic decoration method of claim 15, wherein the step of receiving the input data comprises:
receiving the input data from one or more cameras.

18. The electronic decoration method of claim 15, further comprising:
receiving one or more display device configuration parameters of the display device from the display device through the network;
wherein the step of producing the theme data comprises:
producing the theme data according to the input data and the one or more display device configuration parameters.

19. The electronic decoration method of claim 15, further comprising:
storing the theme data; and
when a new subscriber identification is added to the subscription information, transmitting the stored theme data to the display device while the category name of the theme data corresponds to the theme category name of the subscription information and the identification of the display device corresponds to one of the subscriber identifications in the subscription information.

20. The electronic decoration method of claim 15, further comprising:
receiving one or more local environmental parameters from one or more sensing units connected to the display device through the network;
wherein the step of producing the theme data comprises:
producing the theme data according to the input data and the one or more local environmental parameters.
